(19) United States
(12) Patent Application Publication
(10) Pub. No.: US 2016/0039004 A1
(43) Pub. Date: Feb. 11, 2016

(54) Feedstock Formulation and Supercritical Debinding Process for Micro-Powder Injection Moulding

(71) Applicant: Nano and Advanced Materials Institute Limited, Hong Kong (CN)

(72) Inventors: Kwok Keung LEE, Hong Kong (CN); Ming Yin Raymond SHAN, Hong Kong (CN); Wang PANG, Hong Kong (CN); Hiu Ling CHAN, Hong Kong (CN); Wai Lun CHAN, Hong Kong (CN); Bing Kin LEUNG, Hong Kong (CN)

(21) Appl. No.: 14/453,628

(22) Filed: Aug. 7, 2014

(51) Int. Cl. B22F 1/00; C04B 35/64; B22F 3/12

(52) U.S. Cl. CPC B22F 1/0059; B22F 3/12; C04B 35/64

(57) ABSTRACT

The invention uses supercritical fluid technology for removing the binder in the powder injection moulding (PIM) parts. The invention comprises of the feedstock formulation and its supercritical debinding process. In the debinding system, pressure and heat are applied to the carbon dioxide (CO₂) to a certain level, in such a way to transform the CO₂ to supercritical state. The supercritical CO₂ is used as a solvent to remove the binder in the PIM parts.

### FIELD OF INVENTION

The present invention relates to a novel feedstock formulation for powder injection moulding and a process to remove the binder during the aforesaid moulding method utilizing the aforesaid feedstock.

### BACKGROUND OF INVENTION

The powder injection moulding (PIM) process is an efficient method for a mass production of shaped intricate components using fine powders. PIM is derived from polymer injection moulding and involves similar process and technology, including batch sintering processes used in powder metallurgy and ceramic processing. In conventional PIM process, polymer, which is a thermoplastic polymeric binder, is pre-mixed with metal or ceramic powders to form a homogeneous mixture of ingredients, which is also known as feedstock. The feedstock is heated in a screw-fed barrel to melt the binder content and forced under pressure into a die cavity to form the desired component geometry, where it is cooled down and subsequently ejected to result in a green part. The polymer is then removed from the green part by thermal heating to result in a brown part (the debinding process), while the brown part is heated for sintering, allowing densification and shrinking of the powder into a dense solid with the elimination of pores.

The debinding stage, during which polymer is removed, can greatly affect the mechanical properties of the sintered component. A typical feedstock used in PIM contains 35 to 50 vol % of polymer. The polymer must be removed without causing component swelling, surface blistering, or the formation of large pores, which cannot be removed during the sintering process and would reduce the final density and thus compromise mechanical properties. Nowadays, the catalytic debinding process is widely employed to remove the binder in the PIM parts. The process is conducted in a gaseous acid environment, i.e. highly concentrated nitric or oxalic acid, at a temperature of approximately 120° C. which is below the softening temperature of the binder. The acid acts as a catalyst in the decomposition of the polymer. Reaction products are burnt in a natural gas flame at temperatures above 600° C. However, the process releases formaldehyde which causes cancer and air pollution.

### SUMMARY OF INVENTION

In the light of the foregoing background, it is an object of the present invention to provide a process to remove the binder during the PIM with low toxicity and little environmental impact; a novel feedstock formulation for PIM is also provided.

The present invention, in one aspect, is a composition of a binder for powder injection moulding process comprising 79-83% by volume of paraffin wax, 7-9% by volume of polymer and 2-5% by volume of stearic acid. In one embodiment, the polymer is ethylene butyl acrylates (EBA).

According to another aspect of the present invention, a composition of feedstock for powder injection moulding process comprising 60-66% by volume of powder and 34-40% by volume of the binder of the first aspect is provided.

In yet another aspect, the present invention provides a method of producing a shaped product from powders comprising

a) providing a feedstock comprising a powder and the binder of the first aspect;

b) mixing the powders with the binder;

c) moulding the feedstock to obtain green part by heating;

d) debinding the binder from the green part using supercritical CO₂ to obtain brown part; and

e) sintering said brown part to obtain sintered part;

wherein, supercritical CO₂ is used as a extracting solvent to debind the binder in the step (d), and the binder comprises 79-83% by volume of paraffin wax, 7-9% by volume of polymer and 2-5% by volume of stearic acid. In one embodiment, the polymer is ethylene butyl acrylates (EBA).

In one embodiment, in the step (d), liquid CO₂ is heated and pressurized to reach the supercritical state such that the supercritical CO₂ is then used as the extracting solvent. In a further embodiment, the liquid CO₂ is heated to a temperature of 80° C. and pressurized at a pressure of 270 bar. In another further embodiment, the method further comprises a step (d1) of precipitating the extracted binder and condensing supercritical CO₂ discharged from step (d).

In another aspect, the present invention provides a debinding unit for use in powder injection moulding, comprising an extraction chamber wherein supercritical CO₂ is employed as an extracting solvent to debind binders from a green part in the extraction chamber.

In one embodiment, the debinding unit further comprises:

a) a liquid CO₂ reservoir;

b) a high-pressure pump connecting to said liquid CO₂ reservoir;

c) a heater connecting to said high-pressure pump and said extraction chamber; and

d) a green-part inlet connecting to said extraction chamber adapted for said green part to be fed into said extraction chamber;

wherein liquid CO₂, discharged from said liquid CO₂ reservoir, is heated in said heater and pressurized by said high-pressure pump to become supercritical CO₂; and the supercritical CO₂ debinds said binders from said green part in said extraction chamber.

In a further embodiment, the debinding unit further comprises:

d) a separator connecting to said extraction chamber; and

e) a condenser connecting to said separator and said liquid CO₂ reservoir;

wherein extracted binders are precipitated in said separator and CO₂ discharged from said extraction chamber is condensed in said condenser before being recycled to said liquid CO₂ reservoir.

There are many advantages to the present invention. For example, this invention enables green production as the supercritical debinding process is environmental friendly. It also creates new opportunities of developing new materials and reducing production cost by lowering the raw material cost.

### BRIEF DESCRIPTION OF FIGURES

FIG. 1 shows the schematics of supercritical debinding system.

FIG. 2 shows the 316L stainless steel part fabricated via supercritical debinding process.

### DETAILED DESCRIPTION OF THE PREFERRED EMBODIMENTS

As used herein and in the claims, “comprising” means including the following elements but not excluding others.

Supercritical carbon dioxide (CO₂) is a fluid state of carbon dioxide where it is held at or above its critical temperature and critical pressure. Supercritical CO₂ is becoming an important commercial and industrial solvent due to its role in chemical extraction in addition to its low toxicity and little environmental impact. The relatively low temperature of the process and the stability of CO₂ also allow most compounds of the binder to be extracted with little damage or denaturing of the components. In addition, the solubilities of many extracted compounds in CO₂ vary with pressure, which allows selective extraction. However, application of supercritical CO₂ as solvent in PIM process is still a challenge, since there is no suitable binder available which is compatible with supercritical CO₂ debinding process.

The present invention provides a supercritical CO₂ debinding system for the debinding-process of PIM process and a compatible binder formulation therefor. The system can transform the CO₂ from liquid phase to supercritical state, which then passes through the PIM part processing chamber. The supercritical CO₂ performs like a solvent to remove the binder from the green parts. In addition, adjusted formulation of the binder is also provided in this invention to increase the efficiency of the debinding process using supercritical CO₂ and the quality of the final product in terms of density and strength. Utilizing the formulation and process provided by the present invention, 316L stainless steel parts with the hardness of over 120 HV and the density of over 7.9 g/cm³ can be produced.

In one embodiment, a developed process for manufacturing 316L stainless steel parts involves the following steps:

1. Analyzing the size of powders for manufacturing 316L stainless steel according to normal standard in the art;

2. Mixing powders with binders to form a feedstock, the formulations of the feedstock and the binder according to one embodiment of the instant invention are shown in Tables 1 and 2, respectively; in one embodiment, the polymer is ethylene butyl acrylates (EBA);

3. Moulding the feedstock to obtain a green part by heating;

4. Debinding the binders from the green part using supercritical CO₂ as an extracting solvent to obtain a brown part;

5. Sintering the brown part to obtain a sintered part.

Extraction from PIM parts is performed in the extraction chamber with a continuous flow of CO₂.

TABLE 1
The Composition of Feedstock

| Materials | Volume % | Function |
|---|---|---|
| Powder | 60-66 | Forming the structure of the components/ |
| | | products. |
| Binder | 34-40 | Binding the stainless powder for injection |
| | | moulding process and maintaining the structure |
| | | before sintering in order to achieve near net-shape |
| | | forming of stainless components. |

TABLE 2
The Composition of the Binder in the Feedstock of Table 1

| Materials | Role | Volume % | Function/Characteristics |
|---|---|---|---|
| Paraffin | Primary binder | 79-83 | Material Extracted in the |
| Wax (PW) | | | supercritical debinding process. |
| Polymer | Backbone | 7-9 | Branching polymer to |
| | binder | | maintain the structure of the |
| | (Skeleton) | | moulded part for shape retention |
| | | | after debinding process. |
| Stearic | Surfactant or | 2-5 | Enhance the adhesion between |
| Acid (SA) | bonding agent | | the powder and binder. |

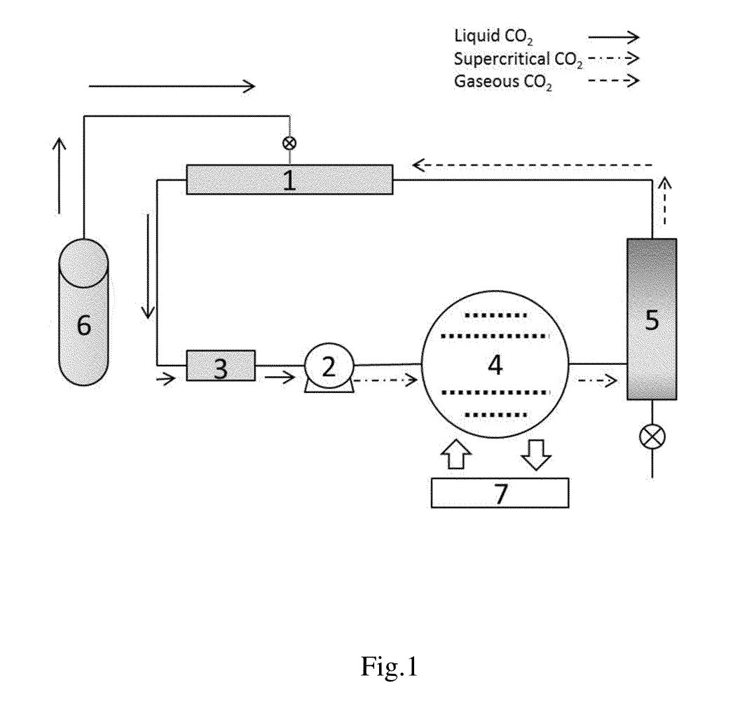

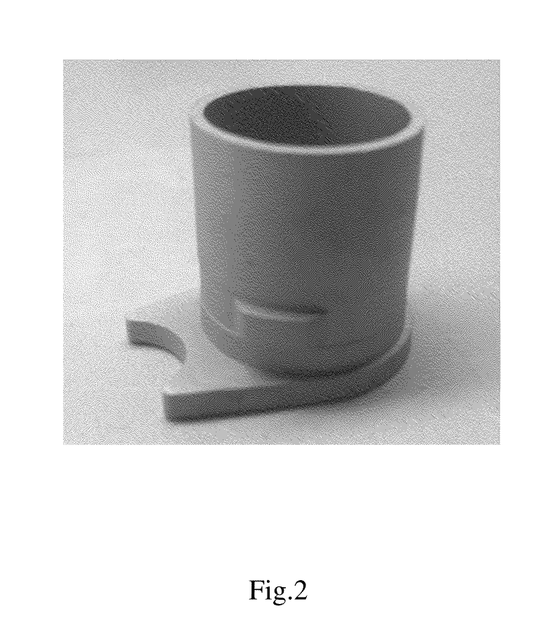

FIG. 1 shows the schematics of the supercritical debinding system according to one embodiment of the present invention. First, CO₂ is discharged from a liquid CO₂ reservoir (6) and then passes through a condessor (1) to ensure all the CO₂ is in liquid state. The liquid CO₂ is then heated in the heater (3) to a temperature of 80° C. and pressurized by a high-pressure pump (2) to a pressure of 270 bar to reach the supercritical state. Supercritical CO₂ enters the extraction chamber (4) where debinding takes place in which binders are removed from the green part by the supercritical CO₂. A green-part inlet is connected to the extraction chamber (4) adapted such that the green parts can be fed into the extraction chamber (4). The extraction chamber (4) is hermetically closed and heated by a heat exchanger (7) to maintain the temperature and pressure inside the extraction chamber (4) so that CO₂ is remained at its supercritical state during the entire debinding process for 2 hours. Afterwards, the extracted binder and CO₂ leave the extraction chamber (4) and the extracted binder is precipitated and collected in separators (5), where CO₂ becomes gaseous. Gaseous CO₂ is then recycled back to the system and returns to the liquid state by condensation in the condenser (1) before returning to the heater (3). In addition to the system design, compositions of the feedstock and binder are also critical to the efficiency of the supercritical CO₂ debinding process and the quality of the final product. Results show that the supercritical CO₂ can efficiently remove the binders from the green parts especially the wax-based binder. FIG. 2 shows a final product fabricated by the powder injection moulding process in which supercritical debinding system according to one embodiment of the present invention is used.

Supercritical CO₂ debinding process is capable of replacing the conventional debinding method which is essential in removing binders from PIM parts. The uniqueness of the invention enables green production as the supercritical debinding CO₂ process can eliminate hazardous acids and solvents without emission of volatile organic matters, and therefore is more environmental-friendly. It creates new opportunities of developing new materials and reduces the production cost by lowering the raw material cost. Besides, supercritical CO₂ debinding process can also reduce debinding time thereof. The comparison data is shown in Tables 3 and 4 below.

Big Part Study

Tables 3 (a)-(c) are comparison data for 30 g 316L stainless steel parts (big part) used in the fabrication of watches and clocks. Table 3(a) shows the machine costs comparison (in Hong Kong Dollars) between PIM processes with catalyst debinding process (column A) and supercritical CO₂ debinding process (column B), demonstrating that the cost of production line reduces by 7.12%, while the cost of the debinding machine reduces by 25%.

TABLE 3 (a)
Machines Costs Comparison of Big Part (in HK Dollars)

| Process | A | B |
|---|---|---|
| Injection Molding | 890,000 | 890,000 |
| Debinding | 960,000 | 720,000 |
| Sintering | 1,500,000 | 1,500,000 |
| Misc (trays, tools etc.) | 20,000 | 20,000 |

Table 3(b) shows the raw material costs comparison (in Hong Kong Dollars) between PIM processes with catalytic debinding process (column A) and supercritical CO₂ debinding process (column B). The raw material cost of 1 kg of commercially available 316L stainless steel (model 316LA from BASF Hong Kong Limited), which would be used for PIM process with catalytic debinding, is shown in column A, whereas the raw material cost for 1 kg of 316L stainless steel, according to one embodiment of this invention, that would be used for the supercritical CO₂ debinding process is shown in column B The result shows that the cost of raw materials for the supercritical debinding process of this invention reduces by 32.66%.

TABLE 3 (b)
Material Costs Comparison of 1 kg Feedstock of Big Part (in HK Dollars)

| Process | A | B | |
|---|---|---|---|
| 316L powder | 432 | 287.28 | (945 g) |
| Polymer powder | | 0.13376 | (7.6 g) |
| Stearic Acid | | 0.61248 | (2.9 g) |
| Paraffin wax | | 2.8925 | (44.5 g) |
| Total | 432 | 290.9 | |

TABLE 3(c)
Running Costs Comparison of Big Part (in HK Dollars)

| | | Produce/day | | Defect rate | | Good parts | | Time need | | Running Cost | |
|---|---|---|---|---|---|---|---|---|---|---|---|
| | Specification | A | B | A | B | A | B | A | B | A | B |
| Design and Fabrication of the mould (2 cavities in 1 mould, maximum no. of shot: 100,000 shots) | | | | | | | | | | 30,000 | 30,000 |
| Injection | 2 part/shot/ | 2,200 | 2,200 | 5% | 5% | 2,090 | 2,090 | 12 hr | 12 hr | 32 | 32 |
| molding | 40 s | | | | | | | | | | |
| Checking | 8 hr working | 2,090 | 2,090 | 5% | 5% | 1,986 | 1,986 | 8 hr | 8 hr | 640 | 640 |
| green | hour/day | | | | | | | | | | |
| parts | | | | | | | | | | | |
| Debinding | 72 tray/30 L | 1,728 | 1,728 | 0.004% | 0.004% | 1,728 | 1,728 | 8 hr | 2 hr | 130 | 80 |
| | furnace | | | | | | | | | | |
| Sintering | 30 L furnace | 1,728 | 1,728 | 0.60% | 0.60% | 1,718 | 1,718 | 9 hr | 9 hr | 2,500 | 2,500 |

Table 3(c) shows the running costs/time comparison (in Hong Kong Dollars) between PIM processes with catalyst debinding process (column A) and supercritical CO₂ debinding process (column B). The result shows that the debinding time reduces from 8 hours to 2 hours. The result further shows that the running cost (in which the material cost is also included) of the whole process with supercritical CO₂ debinding reduces by 38.46% while the cost of each part of the process with supercritical CO₂ debinding reduces by 28.83%.

Small Part Study

Tables 4 (a)-(c) show the comparison data for 1.67 g 316L stainless steel parts (small part) used in electronic and electrical applications. Table 4(a) shows the machine costs comparison (in Hong Kong Dollars) between PIM processes with catalyst debinding process (column A) and supercritical CO₂ debinding process (column B), demonstrating that the cost of production line reduces by 7.12%, while the cost of the debinding machine reduces by 25%.

TABLE 4 (a)
Machines Costs Comparison of Small Part (in HK Dollars)

| Process | A | B |
|---|---|---|
| Injection Molding | 890,000 | 890,000 |
| Debinding | 960,000 | 720,000 |
| Sintering | 1,500,000 | 1,500,000 |
| Misc (trays, tools etc.) | 20,000 | 20,000 |

Table 4(b) shows the raw material costs comparison (in Hong Kong Dollars) between PIM processes with catalytic debinding process (column A) and supercritical CO₂ debinding process (column B). The raw material cost of 1 kg of commercially available 316L stainless steel powder (model 316LA from BASF Hong Kong Limited), which would be used for PIM process with catalytic debinding, is shown in column A, whereas the raw material cost for 1 kg of 316L stainless steel, according to one embodiment of this invention, that would be used for the supercritical CO₂ debinding process is shown in column B. The result shows that the cost of raw materials for the supercritical debinding process of this invention reduces by 32.66%.

TABLE 4 (b)
Material Costs Comparison of 1 kg Feedstock
of Small Part (in HK Dollar)

| Process | A | B | |
|---|---|---|---|
| 316L powder | 432 | 287.28 | (945 g) |
| Polymer powder | | 0.13376 | (7.6 g) |
| Stearic Acid | | 0.61248 | (2.9 g) |
| Paraffin wax | | 2.8925 | (44.5 g) |
| Total | 432 | 290.9 | |

TABLE 4(c)
Running Costs Comparison of Small Part (in HK Dollar)

| | | Produce/day | | Defect rate | | Good parts | | Time need | | Running Cost | |
|---|---|---|---|---|---|---|---|---|---|---|---|
| | Specification | A | B | A | B | A | B | A | B | A | B |
| Design and Fabrication of the mould (2 cavities in 1 mould, maximum no. of shot: 100,000 shots) | | | | | | | | | | 30,000 | 30,000 |
| Injection | 2 part/shot/ | 2,200 | 2,200 | 5% | 5% | 2,090 | 2,090 | 12 hr | 12 hr | 32 | 32 |
| molding | 40 s | | | | | | | | | | |
| Checking | 8 hr working | 2,090 | 2,090 | 5% | 5% | 1,986 | 1,986 | 8 hr | 8 hr | 640 | 640 |
| green | hour/day | | | | | | | | | | |
| parts | | | | | | | | | | | |
| Debinding | 72 tray/30 L | 1,728 | 1,728 | 0.004% | 0.004% | 1,728 | 1,728 | 8 hr | 2 hr | 130 | 80 |
| | furnace | | | | | | | | | | |
| Sintering | 30 L furnace | 1,728 | 1,728 | 0.60% | 0.60% | 1,718 | 1,718 | 9 hr | 9 hr | 2,500 | 2,500 |

Table 4(c) shows the running costs/time comparison (in Hong Kong Dollars) between PIM processes with catalyst debinding process (column A) and supercritical CO₂ debinding process (column B). The result shows that the debinding time reduces from 8 hours to 2 hours. The result further shows that the running cost (in which the material cost is included) of the whole process with supercritical CO₂ debinding reduces by 38.46% while the cost of each part of the process with supercritical CO₂ debinding reduces by 9.75%.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

What is claimed is:

1. A composition of a binder for powder injection moulding process comprising 79-83% by volume of paraffin wax, 7-9% by volume of ethylene butyl acrylates and 2-5% by volume of stearic acid.

2. A composition of feedstock for powder injection moulding process comprising 60-66% by volume of powder and 34-40% by volume of said binder of claim 1.

3. A method of producing a shaped product comprising:
a) providing a feedstock comprising powder and binder;
b) mixing said powders with said binder;
c) moulding said feedstock to obtain the green part;
d) debinding said binder from said green part using supercritical CO₂ to obtain the brown part; and
e) sintering said brown part to obtain the sintered part;
wherein, supercritical CO₂ is used as a extracting solvent to debind the binder in said step (d), said binder comprises 79-83% by volume of paraffin wax, 7-9% by volume of ethylene butyl acrylates and 2-5% by volume of stearic acid.

4. The method of claim 3, wherein in said step (d), liquid CO₂ is heated and pressurized to reach the supercritical state such that the supercritical CO₂ is then used as the extracting solvent.

5. The method of claim 4, wherein said liquid CO₂ is heated to a temperature of 80° C. and pressurized at a pressure of 270 bar.

6. The method of claim 4, further comprising a step (d1) of precipitating and condensing supercritical CO₂ discharged from step (d).
